(19) United States
(12) Patent Application Publication
(10) Pub. No.: US 2024/0217373 A1
(43) Pub. Date: Jul. 4, 2024

(54) TELEMATICS-BASED FLEET CHARGING

(71) Applicant: Rivian IP Holdings, LLC, Plymouth, MI (US)

(72) Inventors: Benjamin VILLAGRA, Palo Alto, CA (US); Tyler Jennings BENNETT, Long Beach, CA (US); Sarah HIPEL, Detroit, MI (US)

(21) Appl. No.: 18/091,230

(22) Filed: Dec. 29, 2022

(51) Int. Cl. B60L 53/65; B60L 53/62

(52) U.S. Cl. CPC B60L 53/65; B60L 53/62

(57) ABSTRACT

Systems and methods for charging an electric vehicle are disclosed. In some embodiments, the electric vehicle is charged in accordance with received instructions. The electric vehicle may facilitate its charging according to the received instructions. The received instructions are determined based on information associate with another electric vehicle, different from the electric vehicle.

### INTRODUCTION

Chargers for providing energy to electric vehicles may be produced by different manufacturers. Because the chargers are produced by different manufacturers, they may communicate differently and may have differ power output capabilities. There may be challenges to directly communicate with the different chargers and more efficiently charge the electric vehicles. For example, challenges may arise when attempting to directly communicate with the different chargers and coordinate charging of a plurality of vehicles according to the vehicle conditions (e.g., battery state-of-health (SoH)). As another example, challenges may arise when attempting to directly communicate with the different chargers and coordinate charging of a plurality of vehicles to minimize energy costs.

### BRIEF SUMMARY

Systems and methods for charging an electric vehicle are disclosed. In some embodiments, the electric vehicle is charged in accordance with received instructions. The electric vehicle may facilitate its charging according to the received instructions. The received instructions are determined based on information associate with another electric vehicle, different from the electric vehicle.

The embodiments disclosed above are examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example system for charging a vehicle.

FIG. 2 illustrates a diagram showing steps of an exemplary method for charging a vehicle.

FIG. 3 illustrates an example vehicle.

FIG. 4 illustrates a system for providing instructions associated with charging a vehicle.

FIG. 5A is a schematic of an example computer system.

FIG. 5B illustrates example firmware for a vehicle ECU.

### DETAILED DESCRIPTION

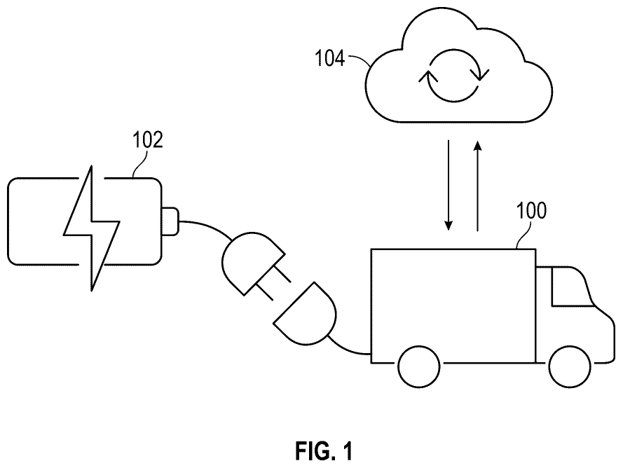

FIG. 1 illustrates an example system for charging a vehicle 100. In some embodiments, the vehicle 100 is an electric vehicle, and the vehicle 100 may be charged by charger 102. In some embodiments, the vehicle 100 is configured to communicate with electronic device 104. In some embodiments, the electronic device 104 is a server (e.g., server 420, server 430) and/or a cloud computing device. In some embodiments, the electronic device 104 is configured to facilitate communications between the vehicle 100 and another vehicle or another electronic device. The communications may include information associated with one or more vehicles and/or the electronic device and instructions associated with charging the vehicle 100, as described in more detail herein.

In some embodiments, the instructions are determined, for example, by the electronic device 104 or a vehicle, based on one or more conditions of the vehicle 100 and/or another vehicle and/or one or more other conditions. The instructions may include a schedule for charging the vehicles determined based on the one or more conditions. The one or more conditions may be indicated by the information associated the vehicle 100 and/or the other vehicle and/or information external to the vehicles. In some embodiments, the information comprises telematics associated with the vehicle 100 and/or the other vehicle. In some embodiments, the information is associated with costs for charging the vehicles. By performing the steps and/or operating the systems disclosed herein, charging of a vehicle or a group of vehicles may be advantageously controlled via these information. These information may be received by the electronic device 104 (e.g., transmitted from a respective vehicle, transmitted from another electronic device, retrieved by the electronic device 104). By controlling charging based on the information and determining the instruction via the electronic device 104, charging control for one or more vehicles may be more easily coordinated and less costly. For example, charging control may not be limited by charger capabilities, which may cause coordination to be more challenging and charging to be more costly.

In some embodiments, although the charger 102 can provide energy to vehicle 100 for charging the vehicle 100, the charger 102 may not be able to control how the energy is provided based on information associated with the vehicle 100. For example, the charger 102 may be produced by a manufacturer different than a manufacturer of the vehicle 100, and there may be challenges for the charger to obtain information associated with the vehicle 100. Therefore, the charger 102 may provide energy to the vehicle 100 in a default manner, and this default manner may not be optimized, for example, to minimize degradation to the vehicle's battery, energy cost, and/or delays to the vehicle's schedule. In some examples, the vehicle 100 may be part of a fleet of vehicles (e.g., fleet of delivery or service vehicles). Because the charger may not be able to obtain information associated with the vehicle 100, the charger 102 may not provide energy to the vehicle 100 in a manner that would, for example, minimize degradation to the fleet's battery, energy costs, and/or delays to the fleet of vehicles.

As described in more detail herein, the disclosed systems and methods allow a vehicle to facilitate its charging based on received instructions, which would, for example, allow the vehicle to be more efficiently charged by different chargers (e.g., a charger that cannot directly communicate with the vehicle to charge the vehicle in a more efficient manner, chargers produced by different manufacturers, chargers with different capabilities). The received instructions may be based on vehicle information (e.g., telematics of the vehicle), information of another vehicle (e.g., telematics of the other vehicle), and other information (e.g., energy costs, environment information) that a charger may not have access to. Based on this information, the vehicle may control its charging behavior (e.g., independent of the charger) to optimize, for example, battery health, energy costs, and/or its schedule of the vehicle or a fleet of vehicles associated with the vehicle. This would also allow the vehicle more options for charging. For example, a more passive and less expensive charger (e.g., a charger that cannot control charging behavior based on vehicle information) may be used to provide energy more efficiently to the vehicle. As another example, the charger may not need additional software to provide energy more efficiently to the vehicle. As another example, the vehicle may control its own charging behavior in a situation when charging control by the vehicle is preferable (e.g., a charger becomes offline). The disclosed systems and methods may also allow charging of the vehicle 100 to be controlled remotely via the other vehicle and/or the electronic device, independent of charger capability.

In some embodiments, the vehicle 100 receives instructions for charging the vehicle 100 from the electronic device 104. In some embodiments, the vehicle 100 receives instructions for charging the vehicle 100 from another vehicle. As described in more detail herein, the instructions may be determined by the vehicle 100, another vehicle, and/or an electronic device different from the vehicle 100 and the other vehicle. By receiving the instructions, the vehicle 100 advantageously facilitates its own charging and achieve the benefits described herein. Based on the received instructions, the vehicle 100 may facilitate its own charging by adjusting how it receives the energy and/or transmits instructions to the charger according to one or more communication standards and/or protocols.

In some embodiments, the instructions for charging the vehicle 100 are part of instructions for charging a plurality of electric vehicles. The plurality of electric vehicles comprises the vehicle 100 and the other vehicle, and the instructions for charging the plurality of electric vehicles comprise instructions for charging the other vehicle. For example, the instructions for charging the vehicle 100 is part of instructions for charging a fleet of vehicles, and the fleet of vehicles include the vehicle 100 and the other vehicle. As an example, an instruction for charging a fleet of vehicles is transmitted (e.g., by an electronic device associated with a fleet manager), and a portion of the instructions associated with charging the vehicle 100 is transmitted to the vehicle 100.

In some embodiments, the instructions are determined (e.g., by the electronic device 104, by another vehicle, by an electronic device in communication with electronic device 104) based on information associated with another vehicle, different from the vehicle 100. As described herein, the information for determining the instructions may not be accessible to a charger. Therefore, by determining the instructions based on this information and transmitting the instructions to the vehicle 100 to facilitate its charging, charging of the vehicle 100 (and/or its associated fleet) may be more optimize (e.g., based on telematics, energy cost information), independent of charger capabilities.

For example, the instructions are determined based on the other vehicle's state-of-health (SoH). As an example, the vehicle 100 and the other vehicle are scheduled to be charged by charger 102. If the vehicle 100's SoH is at a level higher than the other vehicle's SoH, the other vehicle may be instructed to charge before the vehicle 100 (e.g., because the lower SoH vehicle may require a longer charge time). Due to its lower SoH, the other vehicle may be instructed to charge at lower power than the vehicle 100. If the vehicle 100's SoH is at a level lower than the other vehicle's SoH, the vehicle 100 may be instructed to charge before the other vehicle (e.g., because the lower SoH vehicle may require a longer charge time). Due to its lower SoH, the vehicle 100 may be instructed to charge at lower power than the other vehicle.

As another example, the instructions are determined based on the other vehicle's state-of-charge (SoC). As an example, the vehicle 100 and the other vehicle are scheduled to be charged by charger 102. If the vehicle 100's SoC is at a level higher than the other vehicle's SoC, the other vehicle may be instructed to charge before the vehicle 100 (e.g., because the lower SoC vehicle may require a longer charge time). Due to its lower SoC, the other vehicle may be instructed to charge at higher power than the vehicle 100. If the vehicle 100's SoC is at a level lower than the other vehicle's SoH, the vehicle 100 may be instructed to charge before the other vehicle (e.g., because the lower SoC vehicle may require a longer charge time). Due to its lower SoC, the vehicle 100 may be instructed to charge at higher power than the other vehicle.

In some embodiments, the instructions are determined based on costs associated with charging the vehicle. For example, the instructions are based on energy costs. As an example, the instructions may include charging the vehicle to optimize energy and demand charges and reduce overall costs. As another example, the instructions may include charging the vehicle at a time when energy cost is lower (e.g., time when energy demand is lower). As another example, the instructions may include charging the vehicle at a rate based on energy cost (e.g., finish charging the vehicle before energy demand becomes higher, slow down charging during a time when energy demand is higher).

In some embodiments, the instructions are determined based on vehicle data. For example, the vehicle data comprise telematics data such as battery temperature, ambient temperature, and maximum charge rate. The telematics data may be collected by one or more of the vehicle's ECUs, as described herein. For example, the vehicle may be instructed to charge at a rate based on battery temperature and/or ambient temperature (e.g., charge at a lower rate when battery temperature and/or ambient temperature is higher). The vehicle data may be received by the electronic device 104 (e.g., transmitted from a respective vehicle) for determination of charging instructions.

In some embodiments, the information is determined based on an input to the vehicle 100, the other vehicle, an electric device, or any combination thereof, wherein the electric device is different from the vehicle 100 and the other vehicle. For example, the information for determining the charging instructions comprises an input from a user. The user may be a user of the vehicle 100 or the other vehicle or a fleet operator. As an example, the user of the other vehicle may have a greater need for energy, and the user provides an input to the other vehicle, or a fleet operator provides an input to an associated electronic device indicating the greater need. The instructions for charging the vehicle 100 may be determined based on this input, and the vehicle 100 may configured its charging at a later time or a lower rate to accommodate the other vehicle's need.

In some embodiments, the input is associated with a power limit. The power limit may be an amount limit of total power that may be provided to one or more vehicles. For example, the input may be a static power limit for one or more vehicles (e.g., max of 100 kW for the one or more vehicles, maximum currents associated with the power limit for the one or more vehicles), and the group of vehicles are instructed to receive a total amount of power that equates the static limit (e.g., vehicle 100 is instructed to receive a first fraction of the total power, the other vehicle is instructed to receive a second fraction of the total power). In some embodiments, enforcement of the power limit is dependent on time. For example, at a first time, a first power limit is enforced (e.g., max of 100 kW from 6-10 pm). At a second time, a second power limit may be enforced (e.g., max of 300 kW from 10 pm-6 am). Alternatively, at the second time, the first power limit may not be enforced.

In some embodiments, the input is associated with charger information. For example, the input indicates output capability (e.g., as a function of time) of a charger for charging the vehicle 100. The charger information may be provided by a user of the vehicle 100 or the other vehicle or a user of the electronic device (e.g., a fleet operator). The charger information may be determined by a vehicle or an electronic device (e.g., the vehicle or electronic device looks up the charger information and determines its output capability). The charger information may be provided by the charger. The instructions for charging vehicle may be determined based on the provided charger information (e.g., based on a maximum output capability of the charger).

In some embodiments, the information associated with the other vehicle comprises the other vehicle's schedule. For example, the other vehicle's schedule includes departure time, arrival time, target state of charge, its itinerary, or any combination thereof. For example, if the other vehicle's schedule indicates an earlier deployment time (than that of vehicle 100) after charging, then the vehicle 100 is instructed to charge after the other vehicle, so the other vehicle can be promptly deployed. As another example, if the other vehicle's schedule indicates an itinerary including greater travel distance (compared to vehicle 100), then the vehicle 100 is instructed to charge after the other vehicle. The schedule may be updated in real-time, and the instructions for charging the vehicle 100 may be updated in response to the updated schedule.

In some embodiments, the instructions are determined further based on information associated with the vehicle 100. For example, in addition to determining the instructions based on the other vehicle, the instructions are further determined based on information associated with the vehicle 100, such as the vehicle 100's SoH, SoC, schedule, telematics data, and other vehicle information described herein.

In some embodiments, the instructions comprise first charging instructions or second charging instructions, and the second charging instructions are different from the first charging instructions. For example, as described herein, the instructions for charging the vehicle 100 may comprise charging the vehicle 100 according to a first set of instructions or a second set of instructions. The first set of instructions or the second set of instructions may comprise a schedule determined based on, for example, information associated with a vehicle and/or information related to charging. As an example, the first set of instructions includes charging the vehicle 100 before charging the other vehicle, and the second set of instructions includes charging the vehicle 100 after charging the other vehicle. As another example, the first set of instructions includes charging the vehicle 100 at a higher rate than the other vehicle, and the second set of instructions includes charging the vehicle 100 at a lower rate than the other vehicle. As another example, the first set of instructions includes charging the vehicle 100 at a first charger, and the second set of instructions includes charging the vehicle 100 at a second charger, different from the first charger.

In some embodiments, in accordance with a determination that the instructions comprise the first charging instructions, the vehicle 100 facilitates charging of the vehicle 100 according to the first charging instructions. For example, the instructions comprise charging the vehicle 100 at a first time, then the vehicle 100 is configured to charge at the first time (e.g., configured to begin receiving energy at the first time, configured to arrive at the charger by the first time, condition the battery for charging by the first time). As another example, the instructions comprise charging the vehicle at a first rate, then the vehicle is configured to charge at the first rate (e.g., configured to receive energy at the first rate, communicate with the charger to receive energy at the first rate, condition the battery for charging at the first rate). As another example, the instructions comprise charging the vehicle by a first charger, then the vehicle is configured to charge by the first charger (e.g., configured to receive energy according to the capability of the first charger, configured to arrive at the first charger according to the first instructions, condition the battery for charging by the first charger).

In some embodiments, in accordance with a determination that the instructions comprise the second charging instructions, the vehicle 100 facilitates charging of the vehicle 100 according to the second charging instructions. For example, the instructions comprise charging the vehicle 100 at a second time, then the vehicle 100 is configured to charge at the second time (e.g., configured to begin receiving energy at the second time, configured to arrive at the charger by the second time, condition the battery for charging by the second time). As another example, the instructions comprise charging the vehicle at a second rate, then the vehicle is configured to charge at the second rate (e.g., configured to receive energy at the second rate, communicate with the charger to receive energy at the second rate, condition the battery for charging at the second rate). As another example, the instructions comprise charging the vehicle by a second charger, then the vehicle is configured to charge by the second charger (e.g., configured to receive energy according to the capability of the second charger, configured to arrive at the second charger according to the first instructions, condition the battery for charging by the second charger).

In some embodiments, the facilitating charging of the vehicle 100 according to the first charging instructions or the second charging instructions comprises transmitting, by vehicle 100, information associate with the first charging instruction or with the second charging instruction to a charger for charging the vehicle 100. For example, in accordance with the first or second charging instruction, the vehicle 100 transmits information to the charger 102 for charging the vehicle 100. For example, the information is associated with charging initiation, charging rate, and/or charging time. In some embodiments, the vehicle 100 transmits the information to the charger according to one or more of the J1772, DIN70121, ISO15118, IEC61296, and IEC61851 standards and protocols.

In some embodiments, the facilitating charging of the vehicle 100 according to the first charging instructions or the second charging instructions comprises adjusting an amount of power received from a charger for charging vehicle 100. For example, the first charging instructions comprise charging the vehicle 100 at a first rate, and the second charging instructions comprise charging the vehicle 100 at a second rate. In accordance with the first or second charging instructions, the vehicle 100 may adjust its power input (e.g., by controlling an amount of received current) according to the first rate or the second rate, and/or communicate with the charger 102 to control the power being delivered according to the first rate or the second rate.

In some embodiments, the amount of power is a first amount when charging the vehicle 100 according to the first charging instructions. The amount of power is a second amount when charging the vehicle 100 according to the second charging instructions, and the second amount is greater than the first amount. For example, as described herein, the determined instructions include charging the vehicle 100 at a rate based on the information for determining the instructions.

In some embodiments, the first charging instructions comprise initiating charging of the vehicle 100 at a first time, and the second charging instructions comprise initiating charging of the vehicle 100 at a second time, wherein the second time is later than the first time. For example, as described herein, the determined instructions include charging the vehicle at a time based the information for determining instructions. For example, the first charging instructions comprise initiating charging of the vehicle 100 at 10:00 pm in the evening, the vehicle 100 is configured to initiate charging at 10:00 pm (e.g., configured to begin receiving energy at 10:00 pm, configured to arrive at the charger by 10:00 pm, condition the battery for charging by 10:00 pm). The second charging instructions comprise initiating charging of the vehicle 100 at 11:00 pm in the evening (e.g., another vehicle is using the charger before 11:00 pm), the vehicle 100 is configured to initiate charging at 11:00 pm (e.g., configured to begin receiving energy at 11:00 pm, configured to arrive at the charger by 11:00 pm, condition the battery for charging by 11:00 pm).

In some embodiments, the first charging instructions comprise charging of the vehicle 100 at a first rate, and the second charging instructions comprise charging the vehicle 100 at a second rate, wherein the second rate is greater than the first rate. For example, as described herein, the first charging instructions comprise charging the vehicle 100 at a first power level, and the second charging instructions comprise charging the vehicle at a second power level higher than the first power level. As another example, the first charging instructions comprise charging the vehicle 100 via first current, and the second charging instructions comprise charging the vehicle via a second current higher than the first current.

In some embodiments, the vehicle 100 receives second instructions for charging the vehicle 100, the second instructions comprising third charging instructions. In response, the vehicle 100 forgoes the facilitating charging of the vehicle 100 according to the first charging instructions or the second charging instructions and facilitates charging of the vehicle 100 according to the third charging instructions. For example, the vehicle 100 receives updated instructions for charging. The updated instructions may be determined may be based on updated information associated with the vehicle 100, another vehicle, and/or an electronic device in communication with the vehicle 100 and/or the other vehicle. In response to receiving the updated instructions, the vehicle 100 forgoes facilitating charging of the vehicle according to the first or second charging instructions and facilitates charging of the vehicle according to the updated instructions.

In some embodiments, the instructions for charging 100 comprise receiving an update. For example, the update comprises an over-the-air (OTA) update. In accordance with a determination that the instructions comprise receiving the update, the instructions may be determined to include charging the vehicle 100 before receiving the update or after receipt of the update, such that receipt of the update does not interrupt vehicle charging. The instructions may be determined based on a time of the receipt of the update. In some embodiments, the instructions are determined based on the time of receipt of the update. For example, a charging schedule for the vehicle 100 (and other vehicles of e.g., the fleet) is determined based on the time of update, such that the update does not interrupt vehicle charging and/or the update times can be coordinated between the one or more vehicles, and the instructions are determined based on the charging schedule.

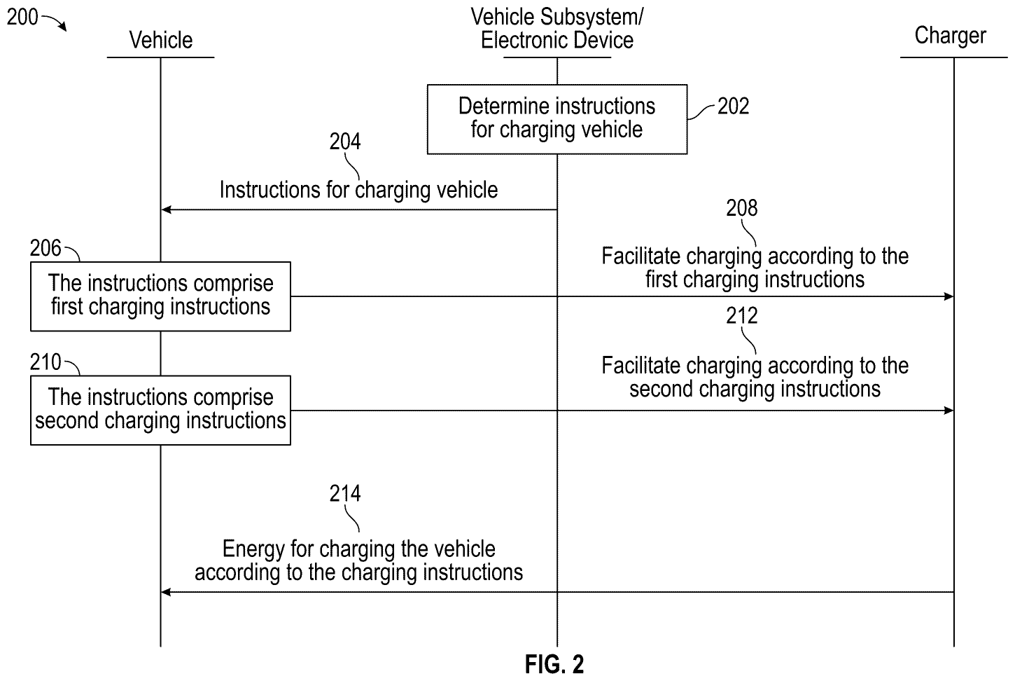

FIG. 2 illustrates a diagram 200 showing steps of an exemplary method for charging a vehicle. In some embodiments, the steps of diagram 200 involve interactions between a vehicle subsystem (e.g., one or more ECU of vehicle 100 or vehicle 300) and a second device (e.g., server 420, server 430, landscape feature 440, computing device 450), another portion of the vehicle ECU, another vehicle ECU (e.g., another one or more ECU of vehicle 100 or vehicle 300), or a landscape feature (e.g., a charger). The steps of diagram 200 may be performed with the systems described with respect to FIGS. 1 and 3-5. It is appreciated that the steps of diagram 200 leverage the features and advantages described with respect to FIGS. 1 and 3-5.

In some embodiments, the vehicle subsystem and/or an electronic device determines instructions for charging a vehicle (step 202). For example, as described with respect to FIG. 1, a vehicle subsystem of vehicle 100 or another vehicle and/or an electronic device (e.g., electronic device 104, associated with a fleet operator) determines the instructions for charging vehicle 100 based on received information.

In some embodiments, the instructions for charging the vehicle are transmitted by the vehicle subsystem and/or the electronic device to the vehicle and received by the vehicle. For example, as described with respect to FIG. 1, the instructions for charging the vehicle are transmitted by a vehicle subsystem of vehicle 100 or another vehicle and/or an electronic device (e.g., electronic device 104, associated with a fleet operator) and received by the vehicle 100.

In some embodiments, in accordance with a determination that the instructions comprise the first charging instructions (step 206), the vehicle facilitates charging of the vehicle according to the first charging instructions (step 208). For example, as described with respect to FIG. 1, the vehicle 100 transmits information associated with the first charging instructions to the charger 102 to facilitate charging. As another example, as described with respect to FIG. 1, the vehicle 100 is configured according to the first charging instructions to facilitate charging.

In some embodiments, in accordance with a determination that the instructions comprise the second charging instructions (step 210), the vehicle facilitates charging of the vehicle according to the second charging instructions (step 212). For example, as described with respect to FIG. 1, the vehicle 100 transmits information associated with the second charging instructions to the charger 102 to facilitate charging. As another example, as described with respect to FIG. 1, the vehicle 100 is configured according to the second charging instructions to facilitate charging.

In some embodiments, in response to the vehicle's facilitation of charging, the charger provides energy to the vehicle according to the first charging instruction or the second charging instruction (step 214). For example, as described with respect to FIG. 1, the charger 102 provides energy to the vehicle 100 according to the first charging instruction or the second charging instruction.

Particular embodiments may repeat one or more steps of the diagram of FIG. 2, where appropriate. Although this disclosure describes and illustrates particular steps of the diagram of FIG. 2 as occurring in a particular order, this disclosure contemplates any suitable steps of the diagram of FIG. 2 occurring in any suitable order (e.g., operations performed by a described device and described with respect to FIGS. 1 and 3-5). Moreover, although this disclosure describes and illustrates an example diagram for facilitating vehicle charging including the particular steps of the diagram of FIG. 2, this disclosure contemplates any suitable steps for facilitating vehicle charging including any suitable steps, which may include all, some, or none of the steps of the diagram of FIG. 2, where appropriate. Furthermore, although this disclosure describes and illustrates particular components, devices, or systems carrying out particular steps of the diagram of FIG. 2, this disclosure contemplates any suitable combination of any suitable components, devices, or systems carrying out any suitable steps of the diagram of FIG. 2.

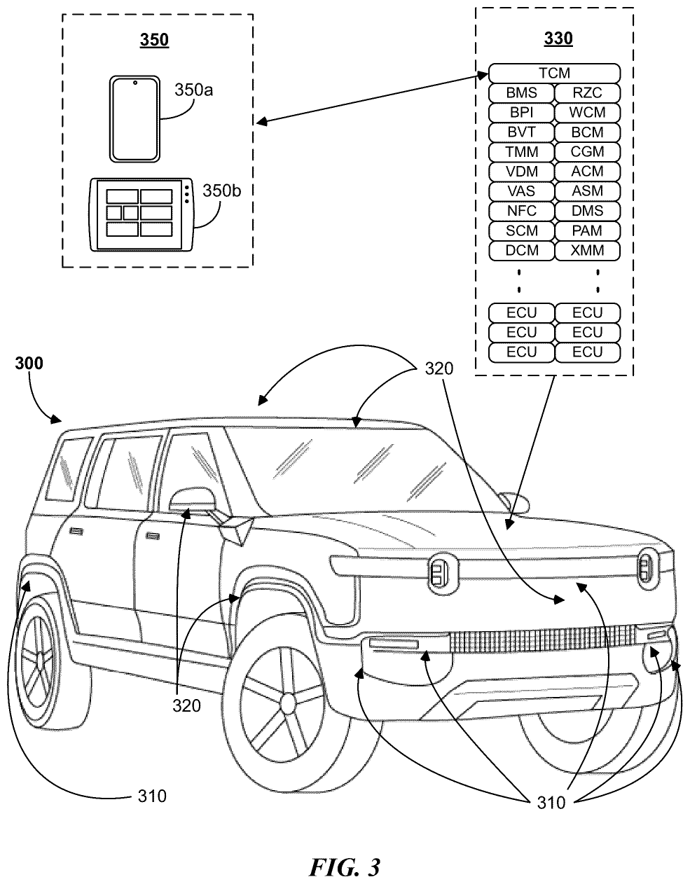

FIG. 3 illustrates an example vehicle 300. In some embodiments, vehicle 300 is vehicle 100. Vehicle 300 may include multiple sensors 310, multiple cameras 320, and a control system 330. In some embodiments, vehicle 300 may be able to pair with a computing device 350 (e.g., smartphone 350a, tablet computing device 350b, or a smart vehicle accessory). As an example and not by way of limitation, a sensor 310 may be an accelerometer, a gyroscope, a magnometer, a global positioning satellite (GPS) signal sensor, a vibration sensor (e.g., piezoelectric accelerometer), a light detection and ranging (LiDAR) sensor, a radio detection and ranging (RADAR) sensor, an ultrasonic sensor, a temperature sensor, a pressure sensor, a humidity sensor, a chemical sensor, an electromagnetic proximity sensor, an electric current sensor, another suitable sensor, or a combination thereof. As an example and not by way of limitation, a camera 320 may be a still image camera, a video camera, a 3D scanning system (e.g., based on modulated light, laser triangulation, laser pulse, structured light, light detection and ranging (LiDAR)), an infrared camera, another suitable camera, or a combination thereof. Vehicle 300 may include various controllable components (e.g., doors, seats, windows, lights, HVAC, entertainment system, security system), instrument and information displays and/or interactive interfaces, functionality to pair a computing device 350 with the vehicle (which may enable control of certain vehicle functions using the computing device 350), and functionality to pair accessories with the vehicle, which may then be controllable through an interactive interface in the vehicle or through a paired computing device 350.

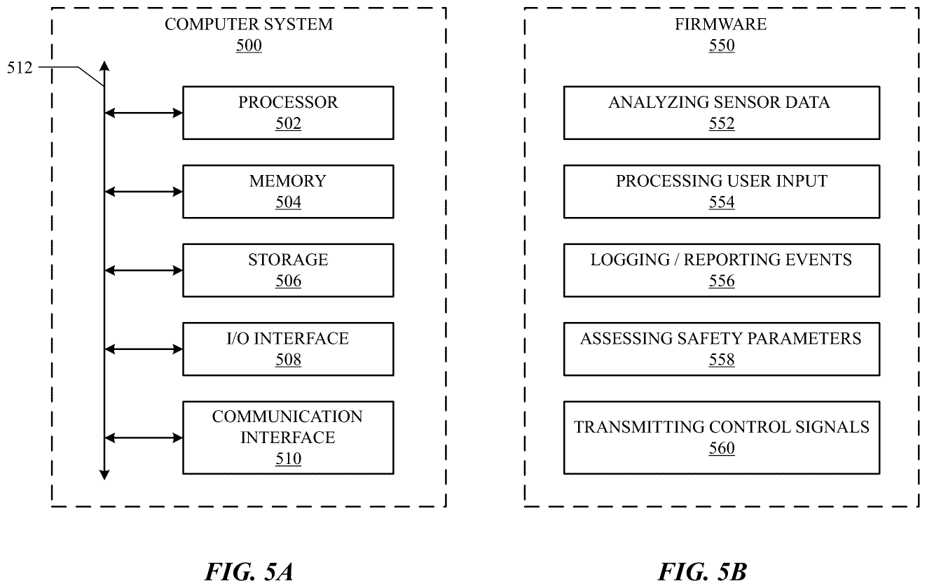

Control system 330 may enables control of various systems on-board the vehicle. As shown in FIG. 3, control system 330 may comprise one or more electronic control units (ECUs), each of which are dedicated to a specific set of functions. Each ECU may be a computer system (as described further in FIG. 5), and each ECU may include functionality provide by one or more of the example ECUs described below.

Features of embodiments as described herein may be controlled by one or more ECUs that provide functionality related to the battery pack of the vehicle. A Battery Management System (BMS) ECU may control and monitor a number of different aspects related to the electric vehicle battery system. Functions that may be controlled by the BMS may include, by way of example and not limitation, controlling the battery pack contactors and pre-charge relay, monitoring the high voltage connector, measuring the pack puncture sensor resistance and pack water sensor resistance, controlling the battery pack fans, measuring busbar temperature, communicating with the BPI and BVT ECUs, and calculate state-of-charge (SoC) and battery state-of-health (SoH). A Battery Power Isolation (BPI) ECU may provide high-voltage sensing, measure the battery pack current, and facilitate determination of pack isolation. A Balancing Voltage Temperature (BVT) ECU may monitor battery module cell voltages, monitor temperature, and execute cell balancing. For example, the BMS ECU may provide information for determining instructions associated with charging of an electric vehicle.

Features of embodiments as described herein may be controlled by a Vehicle Dynamics Module (VDM) ECU. The VDM ECU may control a number of different functions related to aspects of the vehicle's drivetrain, regenerative braking, suspension, steering, traction control, distribution of mass, aerodynamics, and driving modes. In some embodiments, the VDM ECU may, by way of example and not limitation, control vehicle acceleration, control vehicle energy regeneration, calculate torque distribution, provide traction control, control drive modes, provide odometer functions, control driveline disconnects, adjust damping, adjust roll stiffness, adjust ride height, automatically level a vehicle when on a slope, and control the emergency parking brake driver. For example, the VDM ECU may assist a vehicle's an autonomous maneuver to a charger after the receives instructions associated with charging of the vehicle.

Features of embodiments as described herein may be controlled by one or more ECUs that provide functionality to control access to the vehicle. A Vehicle Access System (VAS) ECU may provide passive/active wireless sensors (e.g., Bluetooth) authorizing accessing (i.e., locking or unlocking) the vehicle. A Near-Field Communication (NFC) ECU may support an NFC reader embedded in the vehicle (e.g., in the driver-side exterior door handle or in the armrest of the interior, driver-side door panel) for user authentication. For example, the VAS ECU may facilitate communication between the vehicle and a charger and/or another vehicle for performing the disclosed methods for charging the vehicle.

Features of embodiments as described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device 350, in-vehicle navigation, vehicle-to-vehicle communication, communication between the vehicle and landscape features (e.g., automated toll road sensors, automated toll gates, power dispensers at charging stations), or automated calling functionality. For example, the TCM ECU may facilitate communication between the vehicle and a charger and/or another vehicle for performing the disclosed methods for charging the vehicle.

Features of embodiments as described herein may be controlled by a Central Gateway Module (CGM) ECU. The CGM ECU may serve as the vehicle's communications hub that connects and transfer data to and from the various ECUs, sensors, cameras, motors, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes. In some embodiments, for electric vehicles, the CGM ECU may also control the vehicle charge port door and related light(s) and sensor(s). For example, the CGM ECU may facilitate communications between the vehicle subsystems for performing the disclosed methods for charging the vehicle. As another example, the CGM ECU may facilitate controlling of the vehicle charge port door while performing a method for charging the vehicle.

Features of embodiments as described herein may be controlled by one or more ECUs may provide functions of an automated driving system (ADS) and/or an advanced driver assistance system (ADAS) that may be enabled by a driver of the vehicle to provide one or more functions to support driving assistance and/or automation. An Autonomy Control Module (ACM) ECU may process data captured by cameras 320 and/or sensors 310. In some embodiments, the ACM ECU may provide artificial intelligence functionality to provide and/or refine functions to support driving assistance and/or automation. An Autonomous Safety Module (ASM) ECU may provide functions to support driving safety by monitoring sensors that support self-driving functions. A Driver Monitoring System (DMS) ECU may provide functionality to monitor and inform the control system about the driver's level of attention (e.g., while relying on driving assistance and/or automation functions). The DMS may process data captured by a camera positioned to monitor the driver's gaze. A Park Assist Module (PAM) ECU may provide functions to assist a driver during manual and/or automated parking operations. The PAM ECU may process data captured by cameras 320 and/or sensors 310 in order to determine appropriate control commands. For example, the ADS and/or the ADAS facilities autonomous maneuver of a vehicle to a charger according to instructions associated with charging of the vehicle.

Features of embodiments as described herein may be controlled by an Experience Management Module (XMM) ECU may generate a user interface displayed on a dashboard of the vehicle. The user interface may display information and provide audio output for an infotainment system, including various views around and inside the vehicle. XMM may provide interactive controls for a number of different vehicle functions that may be controlled in conjunction with enabling the designated mode, such as, by way of example and not limitation: controlling interior and exterior lighting, vehicle displays (e.g., instrument cluster, center information display, and rear console display), audio output (e.g., audio processing, echo cancellation, beam focusing), music playback, heating, ventilation, and air conditioning (HVAC) controls, power settings, Wi-Fi connectivity, Bluetooth device connectivity, and vehicle leveling, as well as displaying information in the user interface (e.g., surround view camera feed, distance to nearest charger, and minimum range). In some embodiments, interactive controls provided by XMM may enable interaction with other modules of control system 330. In some embodiments, functions of the ACM and the XMM may be combined together into an Autonomous eXperience Module (AXM) ECU. For example, the ACM and/or the XMM may receive an input (e.g., from a user) for determining instructions associated with charging of the vehicle.

Vehicle 300 may include one or more additional ECUs, such as, by way of example and not limitation: a Central Gateway Module (CGM) ECU, a Telematics Control Module (TCM) ECU, a Vehicle Dynamics Module (VDM) ECU, an Experience Management Module (XMM) ECU, a Vehicle Access System (VAS) ECU, a Near-Field Communication (NFC) ECU, an Autonomy Control Module (ACM) ECU, an Autonomous Safety Module (ASM) ECU, and/or a Driver Monitoring System (DMS) ECU. If vehicle 300 is an electric vehicle, one or more ECUs may provide functionality related to the battery pack of the vehicle, such as a Battery Management System (BMS) ECU, a Battery Power Isolation (BPI) ECU, and/or a Balancing Voltage Temperature (BVT) ECU.

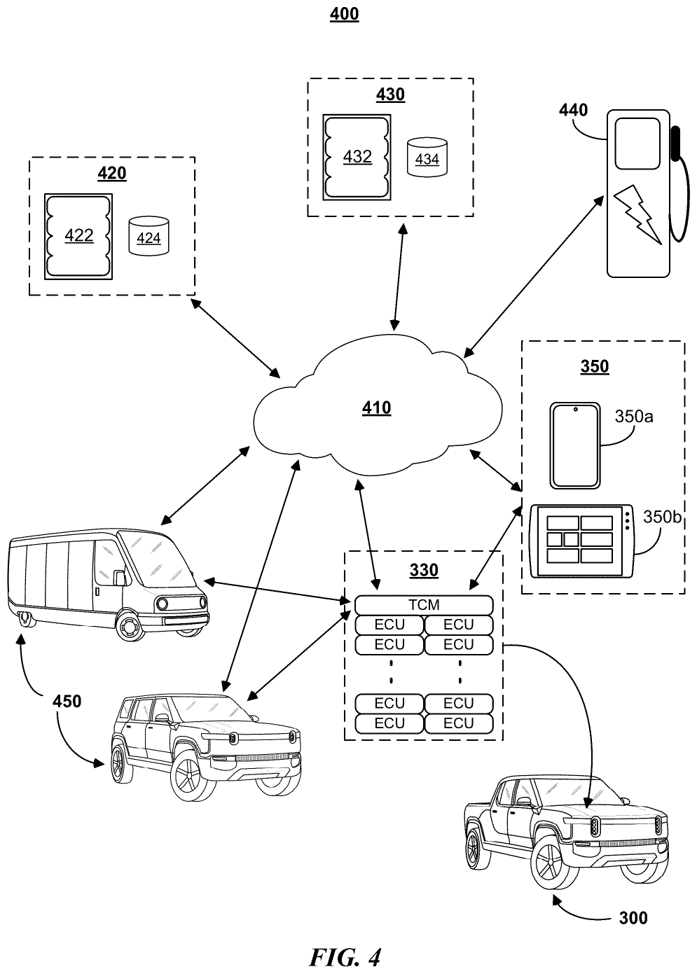

FIG. 4 illustrates a system for providing instructions associated with charging a vehicle. For example, FIG. 4 illustrates an example networked environment 400. Computer system 400 may include a connected vehicle 300 with a control system 330 that is capable of transmitting data to/from a network 410. Network 410 may also be connected to one or more computing servers 420 (e.g., including compute units 422 and storage units 424) associated with a vehicle manufacturer, a vehicle service provider, a vehicle fleet operator, or a vehicle-charging facility provider. Network 410 may also be connected to one or more third-party computing servers 430 (e.g., including compute units 432 and storage units 434) associated with, for example, a smart accessory manufacturer, a group event organizer, service provider, a governmental organization, or an organization associated with route guidance. Networked environment 400 may include one or more landscape features 440 (e.g., automated toll road sensors, smart road signs or road markers, automated toll gates, power dispensers at charging stations). For example, a vehicle may communicate with a power dispenser for charging the vehicle. Networked environment 400 may also include other connected vehicles 450 that may be capable of communicating with vehicle 300 through network 410 and/or directly with vehicle 300 (e.g., by communicating with a TCM ECU of a control system 330 of vehicle 300 when connected vehicle 450 is within range of a short-range communications network, such as Bluetooth). For example, the vehicle 300 and the other connected vehicles 450 may communicate for charging a vehicle (e.g., vehicle 300, vehicle 450, another vehicle). Networked environment 400 may also include one or more computing devices 350 (e.g., smartphone 350a, a tablet computing device 350b, or a smart vehicle accessory) capable of communicating with network 410 and/or directly with vehicle 300.

Networked environment 400 may enable transmission of data and communications between any of the depicted elements. In some embodiments, such information may be communicated in one direction (e.g., a smart road sign broadcasting information related to traffic control or delays due to construction); in other embodiments, information may include two-way communications (e.g., an automated toll gate that processes a request received from vehicle 300 to deduct a toll from a specified account and provides confirmation of the transaction, a server receiving vehicle information and determining instructions associated with charging a vehicle). In particular embodiments, one or more elements of networked environment 400 may include one or more computer systems, as described in further detail with respect to FIG. 5A. In particular embodiments, one or more elements of networked environment 400 perform one or more steps of one or more methods described or illustrated herein. In particular embodiments, software running on one or more elements of networked environment 400 may be controlled by a single entity to perform one or more steps of one or more methods described or illustrated herein or provide functionality described or illustrated herein.

FIG. 5A illustrates an example computer system 500. The computer system 500 may perform one or more steps of a disclosed method, such as determination of instructions associated with charging a vehicle and/or communicating the instructions. Computer system 500 may include a processor 502, memory 504, storage 506, an input/output (I/O) interface 508, a communication interface 510, and a bus 512. Although this disclosure describes one example computer system including specified components in a particular arrangement, this disclosure contemplates any suitable computer system with any suitable number of any suitable components in any suitable arrangement. As an example and not by way of limitation, computer system 500 may be an electronic control unit (ECU), an embedded computer system, a system-on-chip, a single-board computer system, a desktop computer system, a laptop or notebook computer system, a mainframe, a mesh of computer systems, a mobile telephone, a personal digital assistant, a server computing system, a tablet computer system, or a combination of two or more of these. Where appropriate, computer system 500 may include one or more computer systems 500; be unitary or distributed, span multiple locations, machines, or data centers; or reside in a cloud, which may include one or more cloud components in one or more networks. Where appropriate, computer system(s) 500 may perform, at different times or at different locations, in real time or in batch mode, one or more steps of one or more methods described or illustrated herein.

Processor 502 (e.g., compute units 422 and 432) may include hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506 (e.g., storage units 424 and 434). Processor 502 may include one or more internal caches for data, instructions, or addresses.

In particular embodiments, memory 504 includes main memory for storing instructions for processor 502 to execute or data for processor 502 to operate on. In particular embodiments, one or more memory management units (MMUs) reside between processor 502 and memory 504 and facilitate accesses to memory 504 requested by processor 502. In particular embodiments, memory 504 includes random access memory (RAM). This disclosure contemplates any suitable RAM.

In particular embodiments, storage 506 includes mass storage for data or instructions. As an example and not by way of limitation, storage 506 may include a removable disk drive, flash memory, an optical disc, a magneto-optical disc, magnetic tape, or a Universal Serial Bus (USB) drive or two or more of these. Storage 506 may include removable or fixed media and may be internal or external to computer system 500. Storage 506 may include any suitable form of non-volatile, solid-state memory or read-only memory (ROM).

In particular embodiments, I/O interface 508 includes hardware, software, or both, providing one or more interfaces for communication between computer system 500 and one or more input and/or output (1/O) devices. Computer system 500 may be communicably connected to one or more of these I/O devices, which may be incorporated into, plugged into, paired with, or otherwise communicably connected to vehicle 300 (e.g., through the TCM ECU). An input device may include any suitable device for converting volitional user input into digital signals that can be processed by computer system 500, such as, by way of example and not limitation, a steering wheel, a touch screen, a microphone, a joystick, a scroll wheel, a button, a toggle, a switch, a dial, or a pedal. An input device may include one or more sensors for capturing different types of information, such as, by way of example and not limitation, sensors 310 described above. An output device may include devices designed to receive digital signals from computer system 500 and convert them to an output format, such as, by way of example and not limitation, speakers, headphones, a display screen, a heads-up display, a lamp, a smart vehicle accessory, another suitable output device, or a combination thereof. This disclosure contemplates any suitable I/O devices and any suitable I/O interfaces 508 for them. I/O interface 508 may include one or more I/O interfaces 508, where appropriate.

In particular embodiments, communication interface 510 includes hardware, software, or both providing one or more interfaces for data communication between computer system 500 and one or more other computer systems 500 or one or more networks. Communication interface 510 may include one or more interfaces to a controller area network (CAN) or to a local interconnect network (LIN). Communication interface 510 may include one or more of a serial peripheral interface (SPI) or an isolated serial peripheral interface (isoSPI). In some embodiments, communication interface 510 may include a network interface controller (NIC) or network adapter for communicating with an Ethernet or other wire-based network or a wireless NIC (WNIC) or wireless adapter for communicating with a wireless network, such as a WI-FI network or a cellular network.

In particular embodiments, bus 512 includes hardware, software, or both coupling components of computer system 500 to each other. Bus 512 may include any suitable bus, as well as one or more buses 512, where appropriate. Although this disclosure describes a particular bus, any suitable bus or interconnect is contemplated.

Herein, a computer-readable non-transitory storage medium or media may include one or more semiconductor-based or other integrated circuits (ICs) (such, as for example, field-programmable gate arrays or application-specific ICs), hard disk drives, hybrid hard drives, optical discs, optical disc drives, magneto-optical discs, magneto-optical drives, solid-state drives, RAM drives, any other suitable computer-readable non-transitory storage media, or any suitable combination. A computer-readable non-transitory storage medium may be volatile, non-volatile, or a combination of volatile and non-volatile, where appropriate.

FIG. 5B illustrates example firmware 550 for a vehicle ECU 500 as described with respect to control system 330. Firmware 550 may include functions 552 for analyzing sensor data based on signals received from sensors 310 or cameras 320 received through communication interface 510. Firmware 550 may include functions 554 for processing user input (e.g., directly provided by a driver of or passenger in vehicle 300, or provided through a computing device 350) received through I/O interface 508. Firmware 550 may include functions 556 for logging detected events (which may be stored in storage 506 or uploaded to the cloud), as well as functions for reporting detected events (e.g., to a driver or passenger of the vehicle through an instrument display or interactive interface of the vehicle, or to a vehicle manufacturer, service provider, or third party through communication interface 510). Firmware 550 may include functions 558 for assessing safety parameters (e.g., monitoring the temperature of a vehicle battery or the distance between vehicle 300 and nearby vehicles). Firmware 550 may include functions 560 for transmitting control signals to components of vehicle 300, including other vehicle ECUs 500.

In some embodiments, a method comprises: receiving, by a first electric vehicle, instructions for charging the first electric vehicle. The instructions are determined based on information associated with a second electric vehicle, different from the first electric vehicle, the instructions comprise first charging instructions or second charging instructions, and the second charging instructions are different from the first charging instructions. The method further comprises: in accordance with a determination that the instructions comprise the first charging instructions, facilitating, by the first electric vehicle, charging of the first electric vehicle according to the first charging instructions; and in accordance with a determination that the instructions comprise the second charging instructions, facilitating, by the first electric vehicle, charging of the first electric vehicle according to the second charging instructions.

In some embodiments, the facilitating charging of the first electric vehicle according to the first charging instructions or the second charging instructions comprises transmitting, by the first electric vehicle, information associate with the first charging instruction or with the second charging instruction to a charger for charging the first electric vehicle.

In some embodiments, the facilitating charging of the first electric vehicle according to the first charging instructions or the second charging instructions comprises adjusting an amount of power received from a charger for charging the first electric vehicle.

In some embodiments, the amount of power is a first amount when charging the first electric vehicle according to the first charging instructions, the amount of power is a second amount when charging the first electric vehicle according to the second charging instructions, and the second amount is greater than the first amount.

In some embodiments, the information associated with the second electric vehicle comprises the second electric vehicle's state-of-health.

In some embodiments, the information associated with the second electric vehicle comprises the second electric vehicle's state-of-charge.

In some embodiments, the first charging instructions comprise initiating charging of the first electric vehicle at a first time, and the second charging instructions comprise initiating charging of the first electric vehicle at a second time. The second time is later than the first time.

In some embodiments, the first charging instructions comprise charging of the first electric vehicle at a first rate, and the second charging instructions comprise charging the first electric vehicle at a second rate. The second rate is greater than the first rate.

In some embodiments, the information is determined based on an input to the first electric vehicle, the second electric vehicle, an electric device, or any combination thereof. The electric device is different from the first electric vehicle and the second electric vehicle.

In some embodiments, the method further comprises: receiving second instructions for charging the first electric vehicle, the instructions comprise third charging instructions; forgoing the facilitating charging of the first electric vehicle according to the first charging instructions or the second charging instructions; and facilitating, by the first electric vehicle, charging of the first electric vehicle according to the third charging instructions.

In some embodiments, the instructions for charging the first electric vehicle are part of instructions for charging a plurality of electric vehicles, the plurality of electric vehicles comprises the first electric vehicle and the second electric vehicle, and the instructions for charging the plurality of electric vehicles comprise instructions for charging the second electric vehicle.

In some embodiments, the instructions are determined further based on information associated with the first electric vehicle.

In some embodiments, the instructions are determined by the first electric vehicle or the second electric vehicle.

In some embodiments, the instructions are determined by an electronic device different from the first electric vehicle and the second electric vehicle.

In some embodiments, an electric vehicle comprises one or more processors configured to execute any of the above methods.

In some embodiments, a non-transitory computer readable storage medium stores one or more programs, the one or more programs comprising instructions, which when executed by a system with one or more processors and memory, cause the system to perform any of the above methods.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
receiving, by a first electric vehicle, instructions for charging the first electric vehicle, wherein:
the instructions are determined based on information associated with a second electric vehicle, different from the first electric vehicle,
the instructions comprise first charging instructions or second charging instructions, and
the second charging instructions are different from the first charging instructions;
in accordance with a determination that the instructions comprise the first charging instructions, facilitating, by the first electric vehicle, charging of the first electric vehicle according to the first charging instructions; and
in accordance with a determination that the instructions comprise the second charging instructions, facilitating, by the first electric vehicle, charging of the first electric vehicle according to the second charging instructions.

2. The method of claim 1, wherein the facilitating charging of the first electric vehicle according to the first charging instructions or the second charging instructions comprises transmitting, by the first electric vehicle, information associate with the first charging instruction or with the second charging instruction to a charger for charging the first electric vehicle.

3. The method of claim 1, wherein the facilitating charging of the first electric vehicle according to the first charging instructions or the second charging instructions comprises adjusting an amount of power received from a charger for charging the first electric vehicle.

4. The method of claim 3, wherein:
the amount of power is a first amount when charging the first electric vehicle according to the first charging instructions,
the amount of power is a second amount when charging the first electric vehicle according to the second charging instructions, and
the second amount is greater than the first amount.

5. The method of claim 1, wherein the information associated with the second electric vehicle comprises the second electric vehicle's state-of-health.

6. The method of claim 1, wherein the information associated with the second electric vehicle comprises the second electric vehicle's state-of-charge.

7. The method of claim 1, wherein:
the first charging instructions comprise initiating charging of the first electric vehicle at a first time, and
the second charging instructions comprise initiating charging of the first electric vehicle at a second time, wherein the second time is later than the first time.

8. The method of claim 1, wherein:
the first charging instructions comprise charging of the first electric vehicle at a first rate, and
the second charging instructions comprise charging the first electric vehicle at a second rate, wherein the second rate is greater than the first rate.

9. The method of claim 1, wherein the information is determined based on an input to the first electric vehicle, the second electric vehicle, an electric device, or any combination thereof, wherein the electric device is different from the first electric vehicle and the second electric vehicle.

10. The method of claim 1, further comprising:
receiving second instructions for charging the first electric vehicle, wherein the second instructions comprises third charging instructions;
forgoing the facilitating charging of the first electric vehicle according to the first charging instructions or the second charging instructions; and
facilitating, by the first electric vehicle, charging of the first electric vehicle according to the third charging instructions.

11. The method of claim 1, wherein:
the instructions for charging the first electric vehicle are part of instructions for charging a plurality of electric vehicles,
the plurality of electric vehicles comprises the first electric vehicle and the second electric vehicle, and
the instructions for charging the plurality of electric vehicles comprise instructions for charging the second electric vehicle.

12. The method of claim 1, wherein the instructions are determined further based on information associated with the first electric vehicle.

13. The method of claim 1, wherein the instructions are determined by the first electric vehicle or the second electric vehicle.

14. The method of claim 1, wherein the instructions are determined by an electronic device different from the first electric vehicle and the second electric vehicle.

15. An electric vehicle comprising one or more processors configured to execute a method comprising:
receiving, by the first electric vehicle, instructions for charging the first electric vehicle, wherein:
the instructions are determined based on information associated with a second electric vehicle, different from the first electric vehicle,
the instructions comprise first charging instructions or second charging instructions, and
the second charging instructions are different from the first charging instructions;
in accordance with a determination that the instructions comprise the first charging instructions, facilitating, by the first electric vehicle, charging of the first electric vehicle according to the first charging instructions; and
in accordance with a determination that the instructions comprise the second charging instructions, facilitating, by the first electric vehicle, charging of the first electric vehicle according to the second charging instructions.

16. The electric vehicle of claim 15, wherein the facilitating charging of the first electric vehicle according to the first charging instructions or the second charging instructions comprises transmitting, by the first electric vehicle, information associate with the first charging instruction or with the second charging instruction to a charger for charging the first electric vehicle.

17. The electric vehicle of claim 15, wherein the facilitating charging of the first electric vehicle according to the first charging instructions or the second charging instructions comprises adjusting an amount of power received from a charger for charging the first electric vehicle.

18. The electric vehicle of claim 15, wherein:
the instructions for charging the first electric vehicle are part of instructions for charging a plurality of electric vehicles,
the plurality of electric vehicles comprises the first electric vehicle and the second electric vehicle, and
the instructions for charging the plurality of electric vehicles comprise instructions for charging the second electric vehicle.

19. The electric vehicle of claim 15, wherein the instructions are determined by an electronic device different from the first electric vehicle and the second electric vehicle.

20. A non-transitory computer readable storage medium storing one or more programs, the one or more programs comprising instructions, which when executed by a system with one or more processors and memory, cause the system to perform a method comprising:
receiving, by the first electric vehicle, instructions for charging the first electric vehicle, wherein:
the instructions are determined based on information associated with a second electric vehicle, different from the first electric vehicle,
the instructions comprise first charging instructions or second charging instructions, and
the second charging instructions are different from the first charging instructions;
in accordance with a determination that the instructions comprise the first charging instructions, facilitating, by the first electric vehicle, charging of the first electric vehicle according to the first charging instructions; and
in accordance with a determination that the instructions comprise the second charging instructions, facilitating, by the first electric vehicle, charging of the first electric vehicle according to the second charging instructions.
